(19) United States
(12) Patent Application Publication
(10) Pub. No.: US 2022/0306838 A1
(43) Pub. Date: Sep. 29, 2022

(54) POLYAMIDE COMPOSITIONS HAVING A HIGH MODULUS AND A LOW DIELECTRIC CONSTANT AND USE THEREOF

(71) Applicant: Arkema France, Colombes (FR)

(72) Inventors: Guillaume VINCENT, Changshu, Jiangsu (CN); Stéphane BIZET, SERQUIGNY (FR); Clémence PACE, Shimogyo-Ku, Kyoto (JP); Marie POMMIER DE SANTI, OSAKA (JP)

(73) Assignee: Arkema France, Colombes (FR)

(21) Appl. No.: 17/617,877

(22) PCT Filed: Jun. 10, 2020
(86) PCT No.: PCT/FR2020/050986

§ 371 Date: Dec. 9, 2021

(30) Foreign Application Priority Data
Jun. 11, 2019 (FR) FR1906183

(51) Int. Cl. C08K 7/28; C08K 7/14; B29C 45/00

(52) U.S. Cl. CPC C08K 7/28; C08K 7/14; B29C 45/0005; B29C 45/0001; C08K 2201/014; B29K 2077/00

(57) ABSTRACT

The use of a mixture of solid and hollow glass reinforcements with an alloy of at least one polyamide and at least one polyolefin, the mixture of solid and hollow glass reinforcements including from 5 to 50% by weight of hollow glass beads relative to the total of solid and hollow glass reinforcements for the dry preparation at 23° C. of a composition having a modulus at least equal to 8 GPa and a dielectric constant Dk less than or equal to 3.5 as measured according to ASTM D-2520-13, at a frequency of at least 1 GHz, at 23° C., under 50% RH.

### TECHNICAL FIELD

The present invention relates to the use of a mixture of solid and hollow glass reinforcements with an alloy consisting of at least one polyamide and at least one polyolefin for the manufacture of compositions having a high modulus and a low dielectric constant, the method of making same as well as said compositions.

### PRIOR ART

Original equipment manufacturers (OEMs), especially for electronics, telecom or data exchange applications, such as for an autonomous vehicle or for interconnected applications, are increasingly interested in materials used in the protection or cladding of such equipment that have a low dielectric constant.

Indeed, the advantage of such a material integrated, for example, into the casing of a mobile phone is to guarantee the integrity of the signal in an antenna application to ensure a complete, high-speed signal transmission.

Furthermore, in the context of data exchange, the dielectric constant must be as low as possible to ensure the fastest possible data exchange.

The main challenges for such applications are therefore to have the lowest dielectric properties while maintaining a very rigid protective or cladding material. However, in order to obtain a rigid protective or cladding material, it is often necessary to use glass fibers which will give the material a higher modulus and therefore a higher rigidity.

Nevertheless, it is known that the presence of standard glass fibers, for example in a telephone shell, which ensures a good rigidity of said shell, also increases drastically the dielectric constant, and will thus disturb the signal transmission.

It is therefore necessary to have a material that exhibits both stiffness and therefore high modulus properties while maintaining a low dielectric constant so as to ensure complete and high-speed signal transmission or the fastest possible data exchange.

The problem stated above has therefore been solved by the present invention, which concerns the use of a mixture of solid and hollow glass reinforcements with an alloy consisting of at least one polyamide and at least one polyolefin, the said mixture of solid and hollow glass reinforcements comprising from 5 to 50% by weight of hollow glass beads relative to the total of the solid and hollow glass reinforcements, in particular from 5 to 35% by weight of hollow glass beads relative to the total of solid and hollow glass reinforcements, for the dry preparation at 23° C. of a composition having a modulus at least equal to 8 GPa, in particular at least equal to 10 GPa, in particular at least equal to 11 GPa, and a dielectric constant Dk less than or equal to 3.5, in particular less than or equal to 3.3, in particular less than or equal to 3.2 as measured according to ASTM D-2520-13, at a frequency of at least 1 GHz, in particular at a frequency of at least 2 GHz, in particular at a frequency of at least 3 GHz, at 23° C., under 50% RH.

In other words, the present invention relates to the use of a mixture of solid and hollow glass reinforcements with an alloy consisting of at least one polyamide and at least one polyolefin, the said mixture of solid and hollow glass reinforcements comprising from 5 to 50% by weight of hollow glass beads relative to the total of solid and hollow glass reinforcements, in particular from 5 to 35% by weight of hollow glass beads relative to the total of solid and hollow glass reinforcements, to at least preserve the modulus and decrease the dielectric constant of a composition comprising said mixture with said alloy relative to a composition comprising said alloy and glass reinforcements without solid glass reinforcements or said alloy and glass reinforcements without hollow glass reinforcements, said modulus, in the dry state at 23° C., of said composition being at least equal to 8 GPa, in particular at least equal to 10 GPa, in particular at least equal to 11 GPa, and said dielectric constant of said composition being less than or equal to 3.5, in particular less than or equal to 3.3, in particular less than or equal to 3.2, as measured according to ASTM D-2520-13, at a frequency of at least 1 GHz, in particular at a frequency of at least 2 GHz, in particular at a frequency of at least 3 GHz, at 23° C., under 50% RH.

In one embodiment, the composition of the invention is free of polyamide 6 and 66.

The Inventors thus unexpectedly found that the combination of solid and hollow glass reinforcements with an alloy consisting of at least one polyamide and at least one polyolefin, and moreover with a specific proportion of hollow glass beads relative to the total of the solid and hollow glass reinforcements, made it possible to prepare a composition having a high modulus of at least 8 GPa, in particular at least 10 GPa, in particular at least 11 GPa, and a low dielectric constant Dk, less than or equal to 3.5, in particular less than or equal to 3.3, in particular less than or equal to 3.2, thus making it possible to have a rigid material capable of ensuring a complete, high-speed signal transmission or of having the fastest possible data exchange.

A distinction is made between different moduli (e.g. tensile modulus, flexural modulus, etc.). If we consider the flexural modulus, it is always lower than the tensile modulus.

These moduli can be impacted by temperature and by the moisture level in the sample.

In one embodiment, the above defined modulus corresponds to both the flexural modulus and the tensile modulus, the flexural modulus being measured according to ISO 178:2010 and the tensile modulus (or modulus of elasticity E) being measured according to ISO 527-1 and 2:2012.

In another embodiment, the above defined modulus corresponds to the flexural modulus and is measured as above.

In another embodiment, the above defined modulus corresponds to the tensile modulus and is measured as above.

The dielectric constant is defined as the ratio of the permittivity c of the material under consideration to the permittivity of vacuum. It is noted k or Dk and is measured according to ASTM D-2520-13. This is the relative permittivity.

It is measured under 50% relative humidity (RH) at 23° C. on a sample that has been previously dried, notably at 80° C. for 5 days.

In one embodiment, said composition has a dry modulus, at 23° C., of at least 8 GPa, and a dielectric constant Dk, of less than or equal to 3.5, at a frequency of at least 1 GHz, under 50% RH, said modulus corresponding to the tensile modulus and the flexural modulus.

In one embodiment, said composition has a dry modulus, at 23° C., of at least 10 GPa and a dielectric constant Dk, of less than or equal to 3.5, at a frequency of at least 1 GHz, under 50% RH, said modulus corresponding to the tensile modulus and the flexural modulus.

In one embodiment, said composition has a dry modulus, at 23° C., of at least 11 GPa, and a dielectric constant Dk, of less than or equal to 3.5, at a frequency of at least 1 GHz, under at 50% RH, said modulus corresponding to the tensile modulus and the flexural modulus.

In one embodiment, said composition has a dry modulus, at 23° C., of at least 8 GPa and a dielectric constant Dk, of less than or equal to 3.3, at a frequency of at least 1 GHz, under 50% RH, said modulus corresponding to the tensile modulus and the flexural modulus.

In one embodiment, said composition has a dry modulus, at 23° C., of at least 10 GPa and a dielectric constant Dk, of less than or equal to 3.3, at a frequency of at least 1 GHz, under 50% RH, said modulus corresponding to the tensile modulus and the flexural modulus.

In one embodiment, said composition has a dry modulus, at 23° C., of at least 11 GPa and a dielectric constant Dk, of less than or equal to 3.3, at a frequency of at least 1 GHz, under 50% RH, said modulus corresponding to the tensile modulus and the flexural modulus.

In one embodiment, said composition has a dry modulus, at 23° C., of at least 8 GPa and a dielectric constant Dk, of less than or equal to 3.2, at a frequency of at least 1 GHz, under 50% RH, said modulus corresponding to the tensile modulus and the flexural modulus.

In one embodiment, said composition has a dry modulus, at 23° C., of at least 10 GPa and a dielectric constant Dk, of less than or equal to 3.2, at a frequency of at least 1 GHz, under 50% RH, said modulus corresponding to the tensile modulus and the flexural modulus.

In one embodiment, said composition has a dry modulus, at 23° C., of at least 11 GPa and a dielectric constant Dk, of less than or equal to 3.2, at a frequency of at least 1 GHz, under 50% RH, said modulus corresponding to the tensile modulus and the flexural modulus.

In one embodiment, said composition has a dry modulus, at 23° C., of at least 8 GPa and a dielectric constant Dk, of less than or equal to 3.5, at a frequency of up to 2.4 GHz, under 50% RH, said modulus corresponding to the tensile modulus and the flexural modulus.

In one embodiment, said composition has a dry modulus, at 23° C., of at least 10 GPa and a dielectric constant Dk, of less than or equal to 3.5, at a frequency of up to 2.4 GHz, under 50% RH, said modulus corresponding to the tensile modulus and the flexural modulus.

In one embodiment, said composition has a dry modulus, at 23° C., of at least 11 GPa and a dielectric constant Dk, of less than or equal to 3.5, at a frequency of up to 2.4 GHz, under 50% RH, said modulus corresponding to the tensile modulus and the flexural modulus.

In one embodiment, said composition has a dry modulus, at 23° C., of at least 8 GPa and a dielectric constant Dk, of less than or equal to 3.3, at a frequency of up to 2.4 GHz, under 50% RH, said modulus corresponding to the tensile modulus and the flexural modulus.

In one embodiment, said composition has a dry modulus, at 23° C., of at least 10 GPa and a dielectric constant Dk, of less than or equal to 3.3, at a frequency of up to 2.4 GHz, under 50% RH, said modulus corresponding to the tensile modulus and the flexural modulus.

In one embodiment, said composition has a dry modulus, at 23° C., of at least 11 GPa and a dielectric constant Dk, of less than or equal to 3.3, at a frequency of up to 2.4 GHz, under 50% RH, said modulus corresponding to the tensile modulus and the flexural modulus.

In one embodiment, said composition has a dry modulus, at 23° C., of at least 8 GPa and a dielectric constant Dk, of less than or equal to 3.2, at a frequency of up to 2.4 GHz, under 50% RH, said modulus corresponding to the tensile modulus and the flexural modulus.

In one embodiment, said composition has a dry modulus, at 23° C., of at least 10 GPa and a dielectric constant Dk, of less than or equal to 3.2, at a frequency of up to 2.4 GHz, under 50% RH, said modulus corresponding to the tensile modulus and the flexural modulus.

In one embodiment, said composition has a dry modulus, at 23° C., of at least 11 GPa and a dielectric constant Dk, of less than or equal to 3.2, at a frequency of up to 2.4 GHz, under 50% RH, said modulus corresponding to the tensile modulus and the flexural modulus.

In one embodiment, said composition has a dry modulus, at 23° C., of at least 8 GPa and a dielectric constant Dk, of less than or equal to 3.5, at a frequency of at least 1 GHz, under 50% RH, said modulus corresponding to the flexural modulus.

In one embodiment, said composition has a dry modulus, at 23° C., of at least 10 GPa and a dielectric constant Dk, of less than or equal to 3.5, at a frequency of at least 1 GHz, under 50% RH, said modulus corresponding to the flexural modulus.

In one embodiment, said composition has a dry modulus, at 23° C., of at least 11 GPa and a dielectric constant Dk, of less than or equal to 3.5, at a frequency of at least 1 GHz, under 50% RH, said modulus corresponding to the flexural modulus.

In one embodiment, said composition has a dry modulus, at 23° C., of at least 8 GPa and a dielectric constant Dk, of less than or equal to 3.3, at a frequency of at least 1 GHz, under 50% RH, said modulus corresponding to the flexural modulus.

In one embodiment, said composition has a dry modulus, at 23° C., of at least 10 GPa and a dielectric constant Dk, of less than or equal to 3.3, at a frequency of at least 1 GHz, under 50% RH, said modulus corresponding to the flexural modulus.

In one embodiment, said composition has a dry modulus, at 23° C., of at least 11 GPa and a dielectric constant Dk, of less than or equal to 3.3, at a frequency of at least 1 GHz, under 50% RH, said modulus corresponding to the flexural modulus.

In one embodiment, said composition has a dry modulus, at 23° C., of at least 8 GPa and a dielectric constant Dk, of less than or equal to 3.2, at a frequency of at least 1 GHz, under 50% RH, said modulus corresponding to the flexural modulus.

In one embodiment, said composition has a dry modulus, at 23° C., of at least 10 GPa and a dielectric constant Dk, of less than or equal to 3.2, at a frequency of at least 1 GHz, under 50% RH, said modulus corresponding to the flexural modulus.

In one embodiment, said composition has a dry modulus, at 23° C., of at least 11 GPa and a dielectric constant Dk, of less than or equal to 3.2, at a frequency of at least 1 GHz, under 50% RH, said modulus corresponding to the flexural modulus.

In one embodiment, said composition has a dry modulus, at 23° C., of at least 8 GPa and a dielectric constant Dk, of less than or equal to 3.5, at a frequency of up to 2.4 GHz, under 50% RH, said modulus corresponding to the flexural modulus.

In one embodiment, said composition has a dry modulus, at 23° C., of at least 10 GPa and a dielectric constant Dk, of less than or equal to 3.5, at a frequency of up to 2.4 GHz, under 50% RH, said modulus corresponding to the flexural modulus.

In one embodiment, said composition has a dry modulus, at 23° C., of at least 11 GPa and a dielectric constant Dk, of less than or equal to 3.5, at a frequency of up to 2.4 GHz, under 50% RH, said modulus corresponding to the flexural modulus.

In one embodiment, said composition has a dry modulus, at 23° C., of at least 8 GPa and a dielectric constant Dk, of less than or equal to 3.3, at a frequency of up to 2.4 GHz, under 50% RH, said modulus corresponding to the flexural modulus.

In one embodiment, said composition has a dry modulus, at 23° C., of at least 10 GPa and a dielectric constant Dk, of less than or equal to 3.3, at a frequency of up to 2.4 GHz, under 50% RH, said modulus corresponding to the flexural modulus.

In one embodiment, said composition has a dry modulus, at 23° C., of at least 11 GPa and a dielectric constant Dk, of less than or equal to 3.3, at a frequency of up to 2.4 GHz, under 50% RH, said modulus corresponding to the flexural modulus.

In one embodiment, said composition has a dry modulus, at 23° C., of at least 8 GPa, and a dielectric constant Dk, of less than or equal to 3.2, at a frequency of up to 2.4 GHz, under 50% RH, said modulus corresponding to the flexural modulus.

In one embodiment, said composition has a dry modulus, at 23° C., of at least 10 GPa, and a dielectric constant Dk, of less than or equal to 3.2, at a frequency of up to 2.4 GHz, under 50% RH, said modulus corresponding to the flexural modulus.

In one embodiment, said composition has a dry modulus, at 23° C., of at least 11 GPa, and a dielectric constant Dk, of less than or equal to 3.2, at a frequency of up to 2.4 GHz, under 50% RH, said modulus corresponding to the flexural modulus.

In one embodiment, said composition has a dry modulus, at 23° C., of at least 8 GPa, and a dielectric constant Dk, of less than or equal to 3.5, at a frequency of at least 1 GHz, at 50% RH, said modulus corresponding to the tensile modulus.

In one embodiment, said composition has a dry modulus, at 23° C., of at least 10 GPa, and a dielectric constant Dk, of less than or equal to 3.5, at a frequency of at least 1 GHz, under 50% RH, said modulus corresponding to the tensile modulus.

In one embodiment, said composition has a dry modulus, at 23° C., of at least 11 GPa, and a dielectric constant Dk, of less than or equal to 3.5, at a frequency of at least 1 GHz, under 50% RH, said modulus corresponding to the tensile modulus.

In one embodiment, said composition has a dry modulus, at 23° C., of at least 8 GPa, and a dielectric constant Dk, of less than or equal to 3.3, at a frequency of at least 1 GHz, under 50% RH, said modulus corresponding to the tensile modulus.

In one embodiment, said composition has a dry modulus, at 23° C., of at least 10 GPa and a dielectric constant Dk, of less than or equal to 3.3, at a frequency of at least 1 GHz under 50% RH, said modulus corresponding to the tensile modulus.

In one embodiment, said composition has a dry modulus, at 23° C., of at least 11 GPa, and a dielectric constant Dk, of less than or equal to 3.3, at a frequency of at least 1 GHz, under 50% RH, said modulus corresponding to the tensile modulus.

In one embodiment, said composition has a dry modulus, at 23° C., of at least 8 GPa, and a dielectric constant Dk, of less than or equal to 3.2, at a frequency of at least 1 GHz, under 50% RH, said modulus corresponding to the tensile modulus.

In one embodiment, said composition has a dry modulus, at 23° C., of at least 10 GPa, and a dielectric constant Dk, of less than or equal to 3.2, at a frequency of at least 1 GHz, under 50% RH, said modulus corresponding to the tensile modulus.

In one embodiment, said composition has a dry modulus, at 23° C., of at least 11 GPa, and a dielectric constant Dk, of less than or equal to 3.2, at a frequency of at least 1 GHz, under 50% RH, said modulus corresponding to the tensile modulus.

In one embodiment, said composition has a dry modulus, at 23° C., of at least 8 GPa, and a dielectric constant Dk, of less than or equal to 3.5, at a frequency of up to 2.4 GHz, under 50% RH, said modulus corresponding to the tensile modulus.

In one embodiment, said composition has a dry modulus, at 23° C., of at least 10 GPa, and a dielectric constant Dk, of less than or equal to 3.5, at a frequency of up to 2.4 GHz, under 50% RH, said modulus corresponding to the tensile modulus.

In one embodiment, said composition has a dry modulus, at 23° C., of at least 11 GPa, and a dielectric constant Dk, of less than or equal to 3.5, at a frequency of up to 2.4 GHz, under 50% RH, said modulus corresponding to the tensile modulus.

In one embodiment, said composition has a dry modulus, at 23° C., of at least 8 GPa, and a dielectric constant Dk, of less than or equal to 3.3, at a frequency of up to 2.4 GHz, under 50% RH, said modulus corresponding to the tensile modulus.

In one embodiment, said composition has a dry modulus, at 23° C., of at least 10 GPa, and a dielectric constant Dk, of less than or equal to 3.3, at a frequency of up to 2.4 GHz, under 50% RH, said modulus corresponding to the tensile modulus.

In one embodiment, said composition has a dry modulus, at 23° C., of at least 11 GPa, and a dielectric constant Dk, of less than or equal to 3.3, at a frequency of up to 2.4 GHz, under 50% RH, said modulus corresponding to the tensile modulus.

In one embodiment, said composition has a dry modulus, at 23° C., of at least 8 GPa, and a dielectric constant Dk, of less than or equal to 3.2, at a frequency of up to 2.4 GHz, under 50% RH, said modulus corresponding to the tensile modulus.

In one embodiment, said composition has a dry modulus, at 23° C., of at least 10 GPa, and a dielectric constant Dk, of less than or equal to 3.2, at a frequency of up to 2.4 GHz, under 50% RH, said modulus corresponding to the tensile modulus.

In one embodiment, said composition has a dry modulus, at 23° C., of at least 11 GPa, and a dielectric constant Dk, of less than or equal to 3.2, at a frequency of up to 2.4 GHz, under 50% RH, said modulus corresponding to the tensile modulus.

The measurement of the dielectric loss (tan delta or tan(δ)) (or power factor (tan delta or tan(δ)) is used to determine the insulation status of the composition.

Advantageously, the dielectric loss (tan delta) of the said composition is less than or equal to 0.01, as measured on a dry sample, at 23° C., under 50% RH, at a frequency of at least 1 GHz, in particular a frequency of up to 2.4 GHz, according to ASTM D-2520-13.

The sample is then previously dried, particularly at 80° C. for 5 days and tested at 23° C. under 50% RH.

In one embodiment, said composition has a dry modulus, at 23° C. and a dielectric constant Dk, as defined above in the various embodiments, and a dielectric loss (tan delta) less than or equal to 0.01, as measured on a dry sample, at 23° C., under 50% RH, at the same frequency as said dielectric constant in said embodiment.

### Regarding Solid and Hollow Glass Reinforcements

### Solid Glass Reinforcements

Solid glass reinforcements are a glass fiber material with a solid (as opposed to hollow) structure that can have any shape as long as it is solid.

These shapes may be circular or non-circular in cross-section.

A shape with a circular cross-section is defined as a shape having at any point on its circumference a distance equal to the center of the shape and thus represents a perfect or near-perfect circle.

Any glass shape that does not have this perfect or near-perfect circle is therefore defined as a shape with a flat cross-section.

Non-limiting examples of flat cross-section shapes are flat shapes, for example an elliptical, oval or cocoon shape, star shapes, flake shapes, cruciforms, a polygon and a ring.

Solid glass shapes may in particular be short solid glass fibers which preferably have a length of between 2 and 13 mm, preferably 3 to 8 mm, before the compositions are used.

The solid glass fiber may be:
either with a circular cross-section having a diameter of between 4 μm and 25 μm, preferably between 4 and 15 μm.
or with a non-circular cross-section having a L/D ratio (where L represents the largest dimension of the cross-section of the fiber and D the smallest dimension of the cross-section of said fiber) between 2 and 8, particularly between 2 and 4. L and D may be measured by scanning electron microscopy (SEM).

### Hollow Glass Reinforcements

Hollow glass reinforcement are a glass fiber material with a hollow (as opposed to solid) structure, which like solid glass reinforcements, can have any shape as long as it is hollow.

Hollow glass shapes may in particular be short hollow glass fibers which preferably have a length of between 2 and 13 mm, preferably 3 to 8 mm, before the compositions are used.

Hollow glass fibers means glass fibers in which the hollow (or hole or window) within the fiber is not necessarily concentric with the outer diameter of said fiber.

The hollow glass fiber can be:
either with a circular cross-section having a diameter of between 7.5 and 75 μm, preferably between 9 and 25 μm, more preferably between 10 and 12 μm.

It is obvious that the diameter of the hollow (the term “hollow” can also be called hole or window) is not equal to the outer diameter of the hollow glass fiber.

Advantageously, the diameter of the hollow (or hole or window) is from 10% to 80%, in particular from 60 to 80% of the outer diameter of the hollow fiber.
or with a non-circular cross-section having a L/D ratio (where L represents the largest dimension of the cross-section of the fiber and D the smallest dimension of the cross-section of said fiber) between 2 and 8, particularly between 2 and 4. L and D can be measured by scanning electron microscopy (SEM).

Said mixture of solid and hollow glass reinforcements comprises from 5 to 50% by weight of hollow glass beads relative to the total of solid and hollow glass reinforcements, in particular from 5 to 35% by weight of hollow glass beads relative to the total of solid and hollow glass reinforcements.

In one embodiment, said mixture of solid and hollow glass reinforcements comprises from 10 to 50% by weight of hollow glass beads relative to the total of solid and hollow glass reinforcements, in particular from 10 to 35% by weight of hollow glass beads relative to the total of solid and hollow glass reinforcements.

In one embodiment, said mixture of solid and hollow glass reinforcements, in addition to hollow glass beads, comprises solid glass fibers selected from circular cross-section glass fibers, flat cross-section glass fibers and a mixture thereof.

In one embodiment, said mixture of solid and hollow glass reinforcements comprises from 5 to 50% by weight of hollow glass beads relative to the total of solid and hollow glass reinforcements, in particular from 5 to 35% by weight of hollow glass beads relative to the total of solid and hollow glass reinforcements, said hollow glass beads representing the entire proportion of hollow reinforcements.

In this last embodiment, said mixture of solid and hollow glass reinforcements, in addition to hollow glass beads constituting the totality of the hollow reinforcements, comprises solid glass fibers selected from circular cross-section glass fibers, flat cross-section glass fibers and a mixture thereof.

Advantageously, said mixture of glass reinforcements consists of 50 to 95% by weight of solid glass fibers and 5 to 50% by weight of hollow glass beads, in particular 65 to 95% by weight of solid glass fibers and 5 to 35% by weight of hollow glass beads.

Advantageously, said mixture of glass reinforcements consists of 50 to 90% by weight of solid glass fibers and 10 to 50% by weight of hollow glass beads, in particular 65 to 90% by weight of solid glass fibers and 10 to 35% by weight of hollow glass beads.

Advantageously, said solid glass fiber is a glass fiber with a non-circular cross-section.

In one embodiment, the solid glass reinforcement is a glass fiber having a Dk>5 at a frequency of 1 MHz to 5 GHz and in particular a Dk>5 and a Df<0.005 at a frequency of 1 GHz.

Advantageously, the solid glass reinforcement is a glass fiber with a non-circular cross-section and an elastic modulus of less than 76 GPa as measured according to ASTM C1557-03.

Regarding the alloy consisting of at least one polyamide and at least one polyolefin

Advantageously, said alloy consists of at least one polyamide and at least one polyolefin, the polyamide/polyolefin weight ratio of which is between 95/5 and 50/50.

### The Polyolefin:

The polyolefin of said composition may be a grafted (or functionalized) or non-grafted (or non-functionalized) polyolefin or a mixture thereof.

The grafted polyolefin can be a polymer of alpha-olefins having reactive units (functionalities); such reactive units are acid, anhydride, or epoxy functions. By way of example, mention may be made of the preceding non-grafted polyolefins which are nonetheless grafted or co- or ter-polymerized by unsaturated epoxides such as glycidyl (meth)acrylate, or by carboxylic acids or the corresponding salts or esters such as (meth)acrylic acid (which can be completely or partially neutralized by metals such as Zn, etc.) or even by carboxylic acid anhydrides such as maleic anhydride.

Advantageously, the grafted polyolefin is chosen from esters of unsaturated carboxylic acids such as, for example, alkyl acrylates or alkyl methacrylates, preferably said alkyls having from 1 to 24 carbon atoms, examples of alkyl acrylates or methacrylates are in particular methyl methacrylate, ethyl acrylate, n-butyl acrylate, isobutyl acrylate, 2-ethylhexyl acrylate;

vinyl esters of saturated carboxylic acids such as, for example, vinyl acetate or propionate.

Advantageously, said grafted polyolefin defined above is based on polypropylene.

A non-grafted polyolefin is typically a homopolymer or copolymer of alpha olefins or diolefins, such as for example, ethylene, propylene, 1-butene, 1-pentene 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicocene 1-dococene, 1-tetracocene, 1-hexacocene, 1-octacocene and 1-triacontene, preferably propylene or ethylene or dienes such as e.g. butadiene, which can be mixed with a compatible and functional compatibilizer, for example a polyethylene mixed with a maleated Lotader® or a maleated polyethylene, isoprene or 1,4-hexadiene.

In particular, the alpha olefin homopolymer is selected from low density polyethylene (LDPE), high density polyethylene (HDPE), linear low density polyethylene (LLDPE), very low density polyethylene (VLDPE) and metallocene polyethylene;

In particular, the copolymers of alpha olefins or diolefins are selected from ethylene/alpha olefin polymers such as ethylene-propylene, ethylene-butylene, ethylene-propylene-diene monomer, ethylene-octene, alone or in admixture with a polyethylene (PE);

Advantageously, said non-grafted polyolefin defined above is based on polypropylene.

The polyolefin of the composition may also be cross-linked or non-cross-linked, or be a mixture of at least one cross-linked and/or least one non-cross-linked.

### Cross-Linked Polyolefin

The polyolefin of said composition according to the invention may be a non-cross-linked polyolefin and/or a cross-linked polyolefin, said non-cross-linked and/or cross-linked polyolefin being present as a phase dispersed in the matrix formed by the polyamide(s).

Said cross-linked polyolefin is derived from the reaction of two or more products having reactive groups between them.

More particularly, when said polyolefin is a cross-linked polyolefin, it is obtained from at least one product (A) comprising an unsaturated epoxide and at least one product (B) comprising an unsaturated carboxylic acid anhydride.

Product (A) is advantageously a polymer comprising an unsaturated epoxide, this unsaturated epoxide being introduced into said polymer either by grafting or by copolymerization.

The unsaturated epoxide may in particular be selected from the following epoxides:
aliphatic glycidyl esters and ethers such as allyl glycidyl ether, vinyl glycidyl ether, glycidyl maleate and itaconate, glycidyl acrylate and methacrylate, and
alicyclic glycidyl esters and ethers such as 2-cyclohexene-1-glycidyl ether, cyclohexene-4,5-diglycidyl carboxylate, cyclohexene-4-glycidyl carboxylate, 5-norbornene-2-methyl-2-glycidyl carboxylate and endocis-bicyclo(2,2,1)-5-heptene-2,3-diglycidyl dicarboxylate.

According to a first form, the product (A) is a polyolefin grafted with an unsaturated epoxide. Polyolefin is understood to mean a homopolymer or copolymer comprising one or more olefin units such as, for example, ethylene, propylene, or butene-1 units or any other alpha-olefin unit. As examples of polyolefin, mention may be made of:
polyethylene, including low density polyethylene (LDPE), high density polyethylene (HDPE), linear low density polyethylene (LLDPE) and very low density polyethylene (VLDPE); polypropylene; ethylene/propylene copolymers; elastomeric polyolefins such as ethylene-propylene (EPR or EPM) or ethylene-propylene-diene monomer (EPDM); or metallocene polyethylenes obtained by monosite catalysis;
styrene/ethylene-butene/styrene (SEBS) block copolymers; styrene/butadiene/styrene (SBS) block copolymers; styrene/isoprene/styrene (SIS) block copolymers; or styrene/ethylene-propylene/styrene block copolymers;
copolymers of ethylene and at least one product chosen from the salts of unsaturated carboxylic acids, the esters of unsaturated carboxylic acids, and the vinyl esters of saturated carboxylic acids. The polyolefin may in particular be a copolymer of ethylene and alkyl (meth)acrylate or a copolymer of ethylene and vinyl acetate.

According to a second form, the product (A) is a copolymer of alpha-olefin and an unsaturated epoxide and, advantageously, a copolymer of ethylene and an unsaturated epoxide. Advantageously, the amount of unsaturated epoxide may represent up to 15% by weight of the copolymer (A), the amount of ethylene representing at least 50% by weight of the copolymer (A).

One may more particularly cite copolymers of ethylene, of a vinyl ester of saturated carboxylic acid and of an unsaturated epoxide and copolymers of ethylene, of an alkyl (meth)acrylate and of an unsaturated epoxide. Preferably, the alkyl of the (meth)acrylate comprises from 2 to 10 carbon atoms. Examples of alkyl acrylates or methacrylates that can be used include methyl acrylate, methyl methacrylate, ethyl acrylate, n-butyl acrylate, isobutyl acrylate and 2-ethylhexyl acrylate.

According to an advantageous embodiment of the invention, product (A) is a copolymer of ethylene, methyl acrylate and glycidyl methacrylate or a copolymer of ethylene, n-butyl acrylate and glycidyl methacrylate. In particular, the product marketed by ARKEMA under the name LOTADER® AX8900 may be used.

According to another form of the invention, product (A) is a product having two epoxide functions, such as for example the diglycidyl ether of bisphenol A (DGEBA).

Product (B) is advantageously a polymer comprising an unsaturated carboxylic acid anhydride, this unsaturated carboxylic acid anhydride being introduced into the said polymer, either by grafting or by copolymerization.

Examples of unsaturated dicarboxylic acid anhydrides useful as constituents of product (B) include maleic anhydride, itaconic anhydride, citraconic anhydride and tetrahydrophthalic anhydride.

According to a first form, product (B) is a polyolefin grafted with an unsaturated carboxylic acid anhydride. As mentioned above, a polyolefin is a homopolymer or copolymer comprising one or more olefin units such as ethylene, propylene, or butene-1 units or any other alpha-olefin unit. This polyolefin may be chosen in particular from the examples of polyolefins listed above for product (A), when the latter is a polyolefin grafted with an unsaturated epoxide.

According to a second form, product (B) is a copolymer of alpha-olefin and an unsaturated carboxylic acid anhydride and, advantageously, a copolymer of ethylene and an unsaturated carboxylic acid anhydride. Advantageously, the amount of unsaturated carboxylic acid anhydride may represent up to 15% by weight of the copolymer (B), the amount of ethylene representing at least 50% by weight of the copolymer (B).

One may particularly cite copolymers of ethylene, of a vinyl ester of saturated carboxylic acid and of an unsaturated carboxylic acid anhydride and copolymers of ethylene, of an alkyl (meth)acrylate and of an unsaturated carboxylic acid anhydride. Preferably, the alkyl of the (meth)acrylate comprises from 2 to 10 carbon atoms. The alkyl acrylate or methacrylate may be selected from those listed above for product (A).

According to an advantageous version of the invention, product (B) is a copolymer of ethylene, an alkyl (meth)acrylate and an unsaturated carboxylic anhydride. Preferably, product (B) is a copolymer of ethylene, ethyl acrylate and maleic anhydride or a copolymer of ethylene, butyl acrylate and maleic anhydride. In particular, the products marketed by ARKEMA under the names LOTADER® 4700 and LOTADER® 3410 may be used.

It would not be outside the scope of the invention if part of the maleic anhydride of the product (B), according to the first and second forms just described, were partly hydrolysed.

Advantageously, the contents by weight of product (A) and product (B), which are noted respectively [A] and [B], are such that the ratio [B]/[A] is between 3 and 14 and, advantageously, between 4 and 9.

In the composition according to the invention, the cross-linked polyolefin can also be obtained from products (A), (B) as described above and at least one product (C), this product (C) comprising an unsaturated carboxylic acid or an alpha-omega-aminocarboxylic acid.

Product (C) is advantageously a polymer comprising an unsaturated carboxylic acid or an alpha-omega-aminocarboxylic acid, either of these acids being introduced into said polymer by copolymerization.

Examples of unsaturated carboxylic acids which can be used as constituents of product (C) include acrylic acid, methacrylic acid, the carboxylic acid anhydrides mentioned above as constituents of product (B), these anhydrides being completely hydrolysed.

Examples of alpha-omega-aminocarboxylic acids suitable for use as constituents of product (C) include 6-aminohexanoic acid, 11-aminoundecanoic acid and 12-aminododecanoic acid.

Product (C) may be a copolymer of alpha-olefin and an unsaturated carboxylic acid and advantageously a copolymer of ethylene and an unsaturated carboxylic acid. Particular mention may be made of the fully hydrolysed copolymers of product (B).

According to an advantageous version of the invention, product (C) is a copolymer of ethylene and of (meth)acrylic acid or a copolymer of ethylene, of an alkyl (meth)acrylate and of (meth)acrylic acid. The amount of (meth)acrylic acid may be up to 10% by weight and preferably 0.5 to 5% by weight of the copolymer (C). The amount of alkyl (meth)acrylate is generally between 5 and 40% by weight of the copolymer (C).

Advantageously, product (C) is a copolymer of ethylene, butyl acrylate and acrylic acid such as Escor™ 5000 from ExxonMobil.

Preferably, product (C) is a copolymer of ethylene, butyl acrylate and acrylic acid. In particular, the product marketed by BASF under the name LUCALENE® 3110 may be used.

The cross-linked polyolefin dispersed phase can, of course, be produced by reacting one or more products (A) with one or more products (B) and, if appropriate, with one or several products (C).

As already described in WO 2011/015790, catalysts can be used to accelerate the reaction between the reactive functions of products (A) and (B).

Examples of catalysts are given in this document, which can be used in a proportion by weight of 0.1 to 3%, advantageously 0.5 to 1%, based on the total weight of products (A), (B) and, if appropriate, (C).

Advantageously, the contents by weight of product (A), product (B) and product (C), which are noted respectively [A], [B] and [C], are such that the ratio [B]/([A]+[C]) is between 1.5 and 8, the contents by weight of products (A) and (B) being such that [C]≤[A].

Advantageously, the ratio [B]/([A]+[C]) is between 2 and 7.

### Non-Cross-Linked Polyolefin

The composition according to the invention may comprise at least one non-cross-linked polyolefin, said non-cross-linked polyolefin being in the form of a phase dispersed in the matrix formed by the semi-crystalline polyamide(s).

Non-cross-linked polyolefin is understood to mean a homopolymer or copolymer comprising one or more olefin units such as, for example, ethylene, propylene, or butene-1 units or any other alpha-olefin unit as defined above.

Advantageously, said composition comprises at least one cross-linked polyolefin as defined above and at least one non-cross-linked polyolefin as defined above.

In one embodiment, said alloy consists of at least one polyamide and a mixture of a polypropylene-based grafted polyolefin and a polypropylene-based non-grafted polyolefin.

### The Polyamide:

Said at least one polyamide is selected from semi-crystalline polyamides, amorphous polyamides and a mixture thereof.

Advantageously, said at least one polyamide is chosen from an amorphous single polyamide, a semicrystalline polyamide and a mixture of two semicrystalline polyamides.

A semi-crystalline copolyamide, in the sense of the invention, denotes a polyamide that has a glass transition temperature in DSC according to ISO standard 11357-2:2013 as well as a melting temperature (Tm) in DSC according to ISO standard 11357-3:2013, and a crystallization enthalpy during the cooling step at a rate of 20 K/min in DSC measured according to ISO standard 11357-3 of 2013 greater than 30 J/g, preferably greater than 40 J/g.

An amorphous polyamide, in the sense of the invention, denotes a polyamide having only a glass transition temperature (not a melting temperature (Tm)) in DSC according to ISO standard 11357-2:2013, or a polyamide that has very little crystallinity having a glass transition temperature in DSC according to ISO standard 11357-2:2013 and a melting point such that the crystallization enthalpy during the cooling step at a rate of 20 K/min in differential scanning calorimetry, DSC, measured according to ISO standard 11357-3:2013 is less than 30 J/g, in particular less than 20 J/g, preferably less than 15 J/g.

The nomenclature used to define the polyamides is described in ISO standard 1874-1:2011 “Plastiques—Matériaux polyamides (PA) pour moulage et extrusion—Partie 1: Designation”, in particular on page 3 (tables 1 and 2) and is well known to the skilled person.

In a first variant, said alloy consists of a single polyamide which is an amorphous polyamide and at least one polyolefin.

### The Amorphous Polyamide:

Said amorphous polyamide may be a polyamide of formula A/XY, wherein:

A is an aliphatic repeating unit obtained by polycondensation:
of at least one C₅ to C₁₈, preferably C₆ to C₁₂, more preferably C₁₀ to C₁₂, amino acid, or of at least one C₅ to C₁₈, preferentially C₆ to C₁₂, more preferentially C₁₀ to C₁₂, lactam, or of at least one C₄-C₃₆, preferentially C₆-C₁₈, preferentially C₆-C₁₂, more preferentially C₁₀-C₁₂, aliphatic diamine Ca with at least one C₄-C₃₆, preferentially C₆-C₁₈, preferentially C₆-C₁₂, more preferentially C₈-C₁₂ dicarboxylic acid Cb;
XY is an aliphatic repeating unit obtained by polycondensation:
of at least one cycloaliphatic diamine, or at least one linear or branched aliphatic diamine X and
of at least one aromatic dicarboxylic acid or at least one aliphatic dicarboxylic acid Y.

Said amino acid can particularly be chosen from 9-aminononanoic acid, 10-aminodecanoic acid, 10-aminoundecanoic acid, 12-aminododecanoic acid and 11-aminoundecanoic acid and its derivatives, in particular N-heptyl-11-aminoundecanoic acid, in particular 11-aminoundecanoic acid.

Said lactam may be selected from pyrrolidinone, 2-piperidinone, caprolactam, enantholactam, caprylolactam, pelargolactam, decanolactam, undecanolactam, and lauryllactam, in particular lauryllactam.

Said C₄-C₃₆ aliphatic diamine Ca is linear or branched and is notably selected from butanediamine, 1,5-pentamethyldiamine, 2-methyl-1,5-pentanediamine, 1,6-hexamethylenediamine, 1,7-heptanediamine, 1,8-octanediamine, 1,9-nonanediamine, 2-methyl-1,8-octanediamine, 2,2,4-trimethylhexamethylenediamine 2,4,4-trimethylhexamethylenediamine, 1,10-decanediamine, 1,11-undecanediamine, 2-butyl-2-ethyl-1,5-pentanediamine, 1,12-dodecanediamine, 1,13-tridecanediamine 1,14-tetradecanediamine, 1,16-hexadecanediamine, 1,18-octadecanediamine, 1,20-eicosanediamine, 1,22-docosanediamine and fatty acid dimers.

Said C₆-C₁₈ aliphatic diamine Ca is linear or branched and is notably selected from 1,6-hexamethylenediamine, 1,7-heptanediamine, 1,8-octanediamine, 1,9-nonanediamine, 2-methyl-1,8-octanediamine, 2,2,4-trimethylhexamethylenediamine 2,4,4-trimethylhexamethylenediamine, 1,10-decanediamine, 1,11-undecanediamine, 2-butyl-2-ethyl-1,5-pentanediamine, 1,12-dodecanediamine, 1,13-tridecanediamine, 1,14-tetradecanediamine, 1,16-hexadecanediamine, 1,18-octadecanediamine.

Said C₆-C₁₂ aliphatic diamine Ca is linear or branched and is notably selected from 1,6-hexamethylenediamine, 1,7-heptanediamine, 1,8-octanediamine, 1,9-nonanediamine, 2-methyl-1,8-octanediamine, 2,2,4-trimethylhexamethylenediamine 2,4,4-trimethylhexamethylenediamine, 1,10-decanediamine, 1,11-undecanediamine, 2-butyl-2-ethyl-1,5-pentanediamine, 1,12-dodecanediamine.

Said C₁₀-C₁₂ aliphatic diamine Ca is linear or branched and is notably selected from 1,10-decanediamine, 1,11-undecanediamine, 2-butyl-2-ethyl-1,5-pentanediamine, 1,12-dodecanediamine.

Said C₄-C₃₆, preferentially C₆-C₁₈, preferentially C₆-C₁₂, more preferentially C₈-C₁₂, dicarboxylic acid Cb;

Said C₄-C₃₆ dicarboxylic acid Cb is aliphatic and linear and is selected in particular from succinic acid, pentanedioic acid, adipic acid, heptanedioic acid, suberic acid, azelaic acid and sebacic acid, undecanedioic acid, dodecanedioic acid, brassylic acid, tetradecanedioic acid, pentadecanedioic acid, hexadecanedioic acid, octadecanedioic acid, eicosanedioic acid and docosanedioic acid.

Said C₆-C₁₈ dicarboxylic acid Cb is aliphatic and linear and is chosen in particular from adipic acid, heptanedioic acid, suberic acid, azelaic acid and sebacic acid, undecanedioic acid, dodecanedioic acid, brassylic acid, tetradecanedioic acid, pentadecanedioic acid, hexadecanedioic acid, octadecanedioic acid.

Said C₆-C₁₂ dicarboxylic acid Cb is aliphatic and linear and is notably selected from adipic acid, heptanedioic acid, suberic acid, azelaic acid, sebacic acid, undecanedioic acid and dodecanedioic acid.

Said C₈-C₁₂ dicarboxylic acid Cb is aliphatic and linear and is notably selected from suberic acid, azelaic acid, sebacic acid, undecanedioic acid and dodecanedioic acid.

In said aliphatic repeating unit XY, saldi diamine X may particularly be a cycloaliphatic diamine selected from bis(3,5-dialkyl-4-aminocyclohexyl)methane, bis(3,5-dialkyl-4-aminocyclohexyl)ethane, bis(3,5-dialkyl-4-aminocyclo-hexyl)propane, bis(3,5-dialkyl-4-aminocyclo-hexyl)butane, bis-(3-methyl-4-aminocyclohexyl)-methane (BMACM or MACM), p-bis(aminocyclohexyl)-methane (PACM) and isopropylidenedi(cyclohexylamine) (PACP), isophoronediamine, piperazine, amino-ethylpiperazine.

It may also include the following carbon backbones: norbornyl methane, cyclohexylmethane, dicyclohexylpropane, di(methylcyclohexyl), di(methylcyclohexyl) propane. A non-exhaustive list of these cycloaliphatic diamines is given in the publication “Cycloaliphatic Amines” (Encyclopaedia of Chemical Technology, Kirk-Othmer, 4th Edition (1992), pp. 386-405).

In said aliphatic repeating unit XY, said diamine X may be in particular an aliphatic diamine that is linear or branched and is selected from that defined above for the diamine Ca.

In said aliphatic repeating unit XY, the diacid Y may be an aromatic dicarboxylic acid selected from terephthalic acid (denoted T), isophthalic acid (denoted I) and naphthalene diacids.

In said aliphatic repeating unit XY, the diacid Y may be an aliphatic dicarboxylic acid Y and is selected from that defined above for the diacid Cb.

It is obvious that the unit XY is different from the diamine unit Ca. diacid Cb.

Advantageously, A is an aliphatic repeating unit obtained by polycondensation of at least one C₅ to C₁₈, preferentially C₆ to C₁₂, more preferentially C₁₀ to C₁₂, amino acid, or of at least one C₅ to C₁₈, preferentially C₆ to C₁₂, more preferentially C₁₀ to C₁₂, lactam.

Advantageously, XY is an aliphatic repeating unit obtained by polycondensation of at least one cycloaliphatic diamine and at least one aromatic dicarboxylic acid or at least one aliphatic dicarboxylic acid Y.

Advantageously, A is an aliphatic repeating unit obtained by polycondensation of at least one C₅ to C₁₈, preferentially C₆ to C₁₂, more preferentially C₁₀ to C₁₂, amino acid, or

of at least one C₅ to C₁₈, preferentially C₆ to C₁₂, more preferentially C10 to C12 lactam and XY is an aliphatic repeating unit obtained by polycondensation of at least one cycloaliphatic diamine and at least one aromatic dicarboxylic acid or at least one aliphatic dicarboxylic acid Y.

Advantageously, A is an aliphatic repeating unit obtained by polycondensation of at least one C₁₀ to C₁₂, amino acid or at least one C₁₀ to C₁₂ lactam and XY is an aliphatic repeating unit obtained by polycondensation of at least one cycloaliphatic diamine and at least one aromatic dicarboxylic acid or at least one aliphatic dicarboxylic acid Y.

Advantageously, said amorphous polyamide is selected from 11/B10, 12/B10, 11/BI/BT, 11/BI, in particular 11/B10.

Advantageously, A is an aliphatic repeating unit obtained by polycondensation of at least one C₁₀ to C₁₂ amino acid or at least one C₁₀ to C₁₂ lactam, and XY is an aliphatic repeating unit obtained by polycondensation of at least one cycloaliphatic diamine and at least one aromatic dicarboxylic acid.

Advantageously, said amorphous polyamide is selected from 11/BI/BT and 11/BI.

Advantageously, A is an aliphatic repeating unit obtained by polycondensation of at least one C₁₀ to C₁₂ amino acid or at least one C₁₀ to C₁₂ lactam, and XY is an aliphatic repeating unit obtained by polycondensation of at least one cycloaliphatic diamine and at least one aliphatic dicarboxylic acid Y.

Advantageously, said amorphous polyamide is selected from 11/B10, 12/B10, in particular 11/B10.

Advantageously, said alloy consists of a single polyamide which is an amorphous polyamide and of a mixture of a polypropylene-based grafted polyolefin and a polypropylene-based non-grafted polyolefin.

In a second variant, said alloy consists of a single semi-crystalline polyamide or a mixture of two semi-crystalline polyamides and at least one polyolefin.

The polyolefin is as defined above.

### The Semi-Crystalline Polyamide:

The semi-crystalline polyamide may be chosen from aliphatic polyamides, particularly long-chain polyamides, aryl-aliphatic polyamides and semi-aromatic polyamides.

The expression “aliphatic polyamide” means a homopolyamide or copolyamide. It is understood that it may be a mixture of aliphatic polyamides.

The expression “long chain” means that the average number of carbon atoms per nitrogen atom is greater than 8, particularly from 9 to 18.

In one embodiment, said polyamide mixture is a mixture of an aliphatic polyamide, in particular a long-chain polyamide, with an aryl-aliphatic polyamide.

The aliphatic polyamide may be obtained from the polycondensation of a lactam, said lactam can be chosen from pyrrolidinone, 2-piperidinone, caprolactam, enantholactam, caprylolactam, pelargolactam, decanolactam, undecanolactam, and lauryl lactam, particularly lauryl lactam.

The aliphatic polyamide may be obtained from the polycondensation of an amino acid, which can be chosen from 9-aminononanoic acid, 10-aminodecanoic acid, 10-aminoundecanoic acid, 12-aminododecanoic acid and 11-aminoundecanoic acid as well as its derivatives, in particular N-heptyl-11-aminoundecanoic acid, particularly 11-aminoundecanoic acid.

The aliphatic polyamide may be obtained from the polycondensation of a unit X1Y1, where X1 is a diamine and Y is a dicarboxylic acid.

X1 may be a linear or branched C5-C18 aliphatic diamine, and may in particular be selected from 1,5-pentamethyldiamine, 2-methyl-1,5-pentanediamine, 1,6-hexamethylenediamine, 1,7-heptanediamine, 1,8-octanediamine, 1,9-nonanediamine, 2-methyl-1,8-octane-diamine, 2,2,4-trimethylhexamethylenediamine, 2,4,4-trimethylhexamethylenediamine, 1,10-decanediamine, 1,11-undecanediamine, 2-butyl-2-ethyl-1,5-pentanediamine, 1,12-dodecanediamine, 1,13-tridecanediamine, 1,14-tetradecanediamine, 1,16-hexadecanediamine and 1,18-octadecanediamine.

Advantageously, the diamine X1 used is C6-C12, in particular selected from butanediamine, pentanediamine, 2-methyl-1,5-pentanediamine, 1,6-hexamethylenediamine, 1,7-heptanediamine, 1,8-octanediamine, 1,9-nonanediamine, 2-methyl-1,8-octane-diamine, 2,2,4-trimethylhexamethylenediamine, 2,4,4-trimethylhexamethylenediamine, 1,10-decanediamine, 1,11-undecanediamine, 2-butyl-2-ethyl-1,5-pentanediamine, 1,12-dodecanediamine.

Advantageously, the diamine X1 used is C10 to C12, in particular selected from 1,10-decanediamine, 1,11-undecanediamine, 2-butyl-2-ethyl-1,5-pentanediamine and 1,12-dodecanediamine, Y1 may be a C6-C18 aliphatic dicarboxylic acid, in particular C6-C12, especially C10-C12.

The C6 to C18 aliphatic dicarboxylic acid Y1 may be chosen from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid.

The C6 to C12 aliphatic dicarboxylic acid Y1 may be chosen from adipic acid, suberic acid, azelaic acid, sebacic acid, undecanedioic acid, dodecanedioic acid.

The C10 to C12 aliphatic dicarboxylic acid Y1 may be chosen from sebacic acid, undecanedioic acid, dodecanedioic acid.

Advantageously, said aliphatic polyamide is chosen from PA6, PA66, PA610, PA612, PA1010, PA1012, PA1212, PA11 and PA 12, in particular PA1010, PA1012, PA1212, PA11 and PA 12.

The expression “aryl-aliphatic polyamide” means a polyamide obtained from the polycondensation of a unit X2Y1, X2 representing an aryldiamine and Y1 representing an aliphatic dicarboxylic acid as defined above.

Said aryldiamine X2 may be selected from meta-xylylene diamine (MXD) and para-xylylene diamine (PXD).

Advantageously, said aryl-aliphatic polyamide is selected from MXD6, MXD10, MXD12.

Advantageously, said aryl-aliphatic polyamide is selected from MXD10, MXD12.

Advantageously, said mixture of two semi-crystalline polyamides is a mixture of an aliphatic polyamide with an arylaliphatic polyamide.

Advantageously, said mixture of two semicrystalline polyamides is a mixture of an aliphatic polyamide chosen from PA6, PA66, PA610, PA612, PA1010, PA1012, PA1212, PA11 and PA 12, in particular PA1010, PA1012, PA1212, PA11 and PA 12, with an arylaliphatic polyamide chosen from MXD6, MXD10 and MXD12.

Advantageously, said mixture of two semicrystalline polyamides is a mixture of an aliphatic polyamide selected from PA1010, PA1012, PA1212, PA11 and PA 12, with an arylaliphatic polyamide selected from MXD10, MXD12.

The expression “semi-aromatic polyamide” means in particular a semi-aromatic polyamide of a formula as described in EP1505099, in particular a semi-aromatic polyamide of formula B/ZT wherein B is chosen from a unit obtained from the polycondensation of an amino acid as defined above, a unit obtained from the polycondensation of a lactam as defined above, and a unit corresponding to the formula X2Y2, with X2 and Y2 being as defined above; ZT denotes a unit obtained from the polycondensation of a Cx diamine and terephthalic acid, with x representing the number of carbon atoms of the Cx diamine, x being between 4 and 36, advantageously between 6 and 18, advantageously between 6 and 12, advantageously between 10 and 12, in particular a polyamide with formula A/6T, A/9T, A/10T or A/11T, A being as defined above, in particular a polyamide PA 6/6T, a PA 66/6T, a PA 6I/6T, a PA 11/9T, a PA 11/10T, a PA 11/12T, a PA 12/9T, a PA 12/10T, a PA 12/12T, a PA MPMDT/6T, a PA MXDT/6T, a PA 11/6T/10T, a PA MXDT/10T, a PA MPMDT/10T, a PA BACT/10T, a PA BACT/6T, PA BACT/10T/6T, a PA 11/BACT/10T, a PA 11/MPMDT/10T, and a PA 11/MXDT/10T, and block copolymers, particularly polyamide/polyether (PEBA).

T corresponds to terephthalic acid, MXD corresponds to m-xylylenediamine, MPMD corresponds to methylpentamethylenediamine and BAC corresponds to bis(aminomethyl)cyclohexane (1,3 BAC and/or 1, 4 BAC).

Advantageously, the semi-aromatic polyamide is chosen from PA11/9T, PA11/10T, PA 11/12T, PA12/9T, PA12/10T, PA12/12T.

Advantageously, said at least one polyamide is chosen from a single amorphous polyamide, an aryl-aliphatic polyamide, a mixture of an aliphatic polyamide, in particular a long-chain polyamide, with an aryl-aliphatic polyamide, and a mixture of an aliphatic polyamide, in particular a long-chain polyamide, with a semi-aromatic polyamide.

Advantageously, said alloy consists of a mixture of two semi-crystalline polyamides and a mixture of a grafted polyolefin based on polypropylene and an ungrafted polyolefin based on polypropylene.

In one embodiment, the present invention relates to the use as defined above, wherein the composition comprises additives.

### The Additives

The additives may be present up to 2% by weight based on the total weight of the composition, in particular they are present from 1 to 2% by weight relative to the total weight of the composition.

The additive may be chosen among a catalyst, an antioxidant, a heat-stabilizer, a UV stabilizer, a light stabilizer, a lubricant, a flame-retardant agent, a nucleating agent, a chain-lengthener and a colorant.

The term “catalyst” denotes a polycondensation catalyst such as a mineral or organic acid.

Advantageously, the proportion by weight of catalyst is comprised from around 50 ppm to about 5000 ppm, particularly from about 100 to about 3000 ppm relative to the total weight of the composition.

Advantageously, the catalyst is chosen from phosphoric acid (H3PO4), phosphorous acid (H3PO3), hypophosphorous acid (H3PO2), or a mixture thereof.

The antioxidant may in particular be a copper-complex-based antioxidant from 0.05 to 5% by weight, preferably from 0.05 to 1% by weight preferably from 0.1 to 1%.

The expression copper complex denotes in particular a complex between a monovalent or divalent copper salt with an organic or inorganic acid and an organic ligand.

Advantageously, the copper salt is chosen from cupric (Cu(II)) salts of hydrogen halides, cuprous (Cu(I)) salts of hydrogen halides and salts of aliphatic carboxylic acids.

In particular, the copper salts are chosen from CuCl, CuBr, Cul, CuCN, CuCl2, Cu(OAc)2, cuprous stearate.

Copper complexes are in particular described in U.S. Pat. No. 3,505,285.

Said copper-based complex may further comprise a ligand selected from phosphines, in particular triphenylphosphines, mercaptobenzimidazole, EDTA, acetylacetonate, glycine, ethylene diamine, oxalate, diethylene diamine, triethylenetetramine, pyridine, tetrabromobisphenyl-A, derivatives of tetrabisphenyl-A, such as epoxy derivatives, and derivatives of chloro dimethanedibenzo(a,e)cyclooctene and mixtures thereof, diphosphone and dipyridyl or mixtures thereof, in particular triphenylphosphine and/or mercaptobenzimidazole.

Phosphines denote alkylphosphines, such as tributylphosphine or arylphosphines such as triphenylphosphine (TPP).

Advantageously, said ligand is triphenylphosphine.

Examples of complexes and how to prepare them are described in patent CA 02347258.

Advantageously, the quantity of copper in the composition of the invention is comprised from 10 ppm to 1000 ppm by weight, in particular from 20 ppm to 70 ppm, particularly from 50 to 150 ppm relative to the total weight of the composition.

Advantageously, said copper-based complex further comprises a halogenated organic compound.

The halogenated organic compound may be any halogenated organic compound.

Advantageously, said halogenated organic compound is a bromine-based compound and/or an aromatic compound.

Advantageously, said aromatic compound is in particular chosen from decabromediphenyl, decabromodiphenyl ether, bromo or chloro styrene oligomers, polydibromostyrene, the Advantageously, said halogenated organic compound is a bromine-based compound.

Said halogenated organic compound is added to the composition in a proportion of 50 to 30,000 ppm by weight of halogen relative to the total weight of the composition, in particular from 100 to 10,000 particularly from 500 to 1500 ppm.

Advantageously, the copper:halogen molar ratio is comprised from 1:1 to 1:3000, in particular from 1:2 to 1:100.

Particularly, said ratio is comprised from 1:1.5 to 1:15.

Advantageously, the copper complex-based antioxidant.

The thermal stabilizer may be an organic stabilizer or more generally a combination of organic stabilizers, such as a primary antioxidant of the phenol type (for example of the type of Ciba's irganox 245 or 1098 or 1010), or a secondary antioxidant of the phosphite type.

The UV stabilizer may be a HALS, which means Hindered Amine Light Stabilizer or an anti-UV (for example Ciba's Tinuvin 312).

The light stabilizer may be a hindered amine (e.g. Ciba's Tinuvin 770), a phenolic or phosphorus-based stabilizer.

The lubricant may be a fatty acid type lubricant such as stearic acid.

The flame retardant may be a halogen-free flame retardant as described in US 2008/0274355 and in particular a phosphorus-based flame retardant, for example a metal salt selected from a metal salt of phosphinic acid, in particular dialkyl phosphinate salts, in particular aluminium diethylphosphinate salt or aluminium diethylphosphinate salt, a metal salt of diphosphinic acid, a mixture of aluminium phosphinate flame retardant and a nitrogen synergist or a mixture of aluminium phosphinate flame retardant and a phosphorus synergist, a polymer containing at least one metal salt of phosphinic acid, in particular on an ammonium basis, such as ammonium polyphosphate, sulphamate or pentaborate, or on a melamine basis, such as melamine, melamine salts, melamine pyrophosphates and melamine cyanurates, or on a cyanuric acid basis, or a polymer containing at least one metal salt of diphosphinic acid or red phosphorus, antimony oxide, zinc oxide, iron oxide, magnesium oxide or metal borates such as zinc borate, or phosphazene, phospham or phosphoxynitride or a mixture thereof. They may also be halogenated flame retardants such as a brominated or polybrominated polystyrene, a brominated polycarbonate or a brominated phenol.

The nucleating agent may be silica, alumina, clay or talc, in particular talc.

Examples of appropriate chain limiters are monoamines, monocarboxylic acids, diamines, triamines, dicarboxylic acids, tricarboxylic acids, tetraamines, tetracarboxylic acids and, oligoamines or oligocarboxylic acids having respectively in each case 5 to 8 amino or carboxy groups and particularly dicarboxylic acids, tricarboxylic acids or a mixture of dicarboxylic and tricarboxylic acids. As an example, is it possible to use dodecanedicarboxylic acid in the form of a dicarboxylic acid and trimellitic acid as a tricarboxylic acid.

In another embodiment, the present invention relates to the use as defined above, wherein the composition comprises at least one prepolymer, in particular monofunctional NH2, in particular PA11-based.

Advantageously, the composition comprises a single prepolymer.

### The Prepolymer

The prepolymer may be present up to 11% by weight based on the total weight of the composition, in particular from 0.1 to 11% by weight based on the total weight of the composition.

The prepolymer is different from the nucleating agent used as an additive.

The term “prepolymer” refers to oligomers of polyamides necessarily of lower number average molecular weight than the polyamides used in the composition, in particular said prepolymer has a number average molecular weight of 1000-15000 g/mol, in particular 1000-10000 g/mol.

The prepolymer may be chosen from aliphatic, linear or branched, polyamide oligomers, cycloaliphatic polyamide oligomers, semi-aromatic polyamide oligomers, aromatic polyamide oligomers, aliphatic, linear or branched, cycloaliphatic, semi-aromatic and aromatic polyamides having the same definition as above.

The prepolymer or oligomer consequently comes from the condensation:
of at least one lactam, or
of at least one amino acid, or
of at least one diamine with at least one dicarboxylic acid, or a mixture thereof.

The prepolymer or oligomer cannot therefore correspond to the condensation of a diamine with a lactam or an amino acid.

The prepolymer may also be a copolyamide oligomer or a mixture of polyamide and copolyamide oligomers.

For example, the prepolymer is monofunctional NH2, monofunctional CO2H or difunctional CO2H or NH2.

The prepolymer may therefore be mono or difunctional, acid or amine, that is it has a single terminal amine or acid function, when it is monofunctional (in this case the other ending is non-functional, in particular CH3), or two terminal amine functions or two terminal acid functions, when it is difunctional.

Advantageously, the prepolymer is monofunctional, preferably NH2 or CO2H.

It can also be non-functional at both endings, in particular diCH₃.

In one embodiment, the present invention relates to the use as defined above, wherein the composition comprises:

30 to 70%, in particular 35 to 60%, and more particularly 40 to 50% by weight of an alloy consisting of at least one polyamide and at least one polyolefin, as defined above, the polyamide/polyolefin ratio being from 95/5 to 50/50;
30 to 70%, in particular 40 to 65%, and more particularly 50 to 60% by weight of a mixture of solid and hollow glass reinforcement as defined above; and
0 to 11% by weight of at least one prepolymer, in particular 0.1 to 11%;
0 to 5% of fillers and
0 to 2%, preferably 1 to 2% by weight of additives,
the sum of the proportions of each constituent of said composition being equal to 100%.

In another embodiment, the present invention relates to the use as defined above, wherein the composition consists of:

30 to 70%, in particular 35 to 60%, and more particularly 40 to 50% by weight of an alloy consisting of at least one polyamide and at least one polyolefin, as defined above, the polyamide/polyolefin ratio being from 95/5 to 50/50;
30 to 70%, in particular 40 to 65%, and more particularly 50 to 60% by weight of a mixture of solid and hollow glass reinforcement as defined above; and
0 to 11% by weight of at least one prepolymer, in particular 0.1 to 11%;
0 to 5% of fillers and
0 to 2%, preferably 1 to 2% by weight of additives,
the sum of the proportions of each constituent of said composition being equal to 100%.

In one embodiment, the present invention relates to the use as defined above, wherein the composition comprises:

30 to 50%, in particular 35 to 50%, and more particularly 40 to 50% by weight of an alloy consisting of at least one polyamide and at least one polyolefin, as defined above, the polyamide/polyolefin ratio being from 95/5 to 50/50;
50 to 70%, in particular 50 to 65%, and more particularly 50 to 60% by weight of a mixture of solid and hollow glass reinforcement as defined above; and
0 to 11% by weight of at least one prepolymer, in particular 0.1 to 11%;
0 to 5% of fillers and
0 to 2%, preferably 1 to 2% by weight of additives,
the sum of the proportions of each constituent of said composition being equal to 100%.

In yet another embodiment, the present invention relates to the use as defined above, wherein the composition consists of:

30 to 50%, in particular 35 to 50%, and more particularly 40 to 50% by weight of an alloy consisting of at least one polyamide and at least one polyolefin, as defined above, the polyamide/polyolefin ratio being from 95/5 to 50/50;
50 to 70%, in particular 50 to 65%, and more particularly 50 to 60% by weight of a mixture of solid and hollow glass reinforcement as defined above; and
0 to 11% by weight of at least one prepolymer, in particular 0.1 to 11%;
0 to 5% of fillers and
0 to 2%, preferably 1 to 2% by weight of additives,
the sum of the proportions of each constituent of said composition being equal to 100%.

According to another aspect, the present invention relates to a composition in particular useful for injection molding, comprising:

30 to 70%, in particular 35 to 60%, and more particularly 40 to 50% by weight of an alloy consisting of at least one polyamide and at least one polyolefin, as defined above, the polyamide/polyolefin ratio being from 95/5 to 50/50;

30 to 70%, in particular 40 to 65%, and more particularly 50 to 60% by weight of a mixture of solid and hollow glass reinforcement as defined above; and
0 to 11% by weight of at least one prepolymer, in particular 0.1 to 11%;
0 to 5% of fillers and
0 to 2, preferably 1 to 2% by weight of additives,
the sum of the proportions of each constituent of said composition being equal to 100%.

Advantageously, said composition, in particular useful for injection molding, consists of:

30 to 70%, in particular 35 to 60%, and more particularly 40 to 50% by weight of an alloy consisting of at least one polyamide and at least one polyolefin, as defined above, the polyamide/polyolefin ratio being from 95/5 to 50/50;
30 to 70%, in particular 40 to 65%, and more particularly 50 to 60% by weight of a mixture of solid and hollow glass reinforcement as defined above; and
0 to 11% by weight of at least one prepolymer, in particular 0.1 to 11%;
0 to 5% of filler and
0 to 2, 1 to 2% by weight of additives,
the sum of the proportions of each constituent of said composition being equal to 100%.

In one embodiment, said composition particularly useful for injection molding, is comprises:

30 to 50%, in particular 35 to 50%, and more particularly 40 to 50% by weight of an alloy consisting of at least one polyamide and at least one polyolefin, as defined above, the polyamide/polyolefin ratio being from 95/5 to 50/50;
50 to 70%, in particular 50 to 65%, and more particularly 50 to 60% by weight of a mixture of solid and hollow glass reinforcement as defined above; and
0 to 11% by weight of at least one prepolymer, in particular 0.1 to 11%;
0 to 5% of fillers and
0 to 2%, preferably 1 to 2% by weight of additives,
the sum of the proportions of each constituent of said composition being equal to 100%.

In another embodiment, said composition, particularly useful for injection molding, consists of:

30 to 50%, in particular 35 to 50%, and more particularly 40 to 50% by weight of an alloy consisting of at least one polyamide and at least one polyolefin, as defined above, the polyamide/polyolefin ratio being from 95/5 to 50/50;
50 to 70%, in particular 50 to 65%, and more particularly 50 to 60% by weight of a mixture of solid and hollow glass reinforcement as defined above; and
0 to 11% by weight of at least one prepolymer, in particular 0.1 to 11%;
0 to 5% of fillers and
0 to 2%, preferably 1 to 2% by weight of additives,
the sum of the proportions of each constituent of said composition being equal to 100%.

In one embodiment, said composition is free of polyamide 6 and 66.

All the characteristics defined above for the use defined above are valid for the composition as such.

### Regarding Fillers

The composition may also contain fillers. The fillers envisaged include conventional mineral fillers, such as kaolin, magnesia, slag, carbon black, expanded or unexpanded graphite, wollastonite, pigments such as titanium oxide and zinc sulphide, and antistatic fillers.

Advantageously, said composition, in particular useful for injection molding, consists of:

30 to 70% by weight, in particular 35 to 60% by weight, and more particularly 40 to 50% by weight of an alloy consisting of at least one polyamide and at least one polyolefin, as defined above, the polyamide/polyolefin ratio being from 95/5 to 50/50;
30 to 70% by weight, in particular 40 to 65% by weight, and more particularly 50 to 60% by weight of a mixture of solid and hollow glass reinforcement as defined above; and
0 to 11% by weight of at least one prepolymer, in particular 0.1 to 11% by weight;
0 to 5% by weight of fillers, and
0 to 2% by weight, preferably 1 to 2% by weight of additives, the sum of the proportions of each constituent of said composition being equal to 100%.

According to another aspect, the present invention relates to the use of a composition as defined above, for the manufacture of an article in particular for electronics, for telecom applications or for data exchange, such as for an autonomous vehicle or for applications connected to each other.

Advantageously, said article is manufactured by injection molding.

In other words, the present invention relates to a method of preparing an article, in particular for electronics, for telecom applications or for data exchange, such as for an autonomous vehicle or for interconnected applications, comprising a step, in particular by injection moulding, of a composition as defined above.

According to another aspect, the present invention relates to an article obtained by injection molding with a composition as defined hereinbefore.

### EXAMPLES

The invention will now be illustrated in greater detail by means of the following examples without being in any way limited to these.

The various polyamides and copolyamides of the invention were prepared according to the usual techniques for polyamide and copolyamide synthesis.

Synthesis of CoPa 11/10T, representative of the various copolyamides:

the aminoundecanoic, decanediamine and terephthalic acid monomers are loaded together in the reactor according to the desired mass ratio. The medium is first inerted to remove the oxygen that can generate yellowing or secondary reactions. Water can also be charged to improve heat exchange. Two temperature rise and pressure plateaus are conducted. The temperature (T°) and pressure conditions are chosen to allow the medium to melt. After having reached the maintenance conditions, degassing takes place to allow the polycondensation reaction. The medium becomes viscous little by little and the reaction water formed is caused the nitrogen purge or applying a vacuum. When the stoppage conditions are reached, related to the desired viscosity, stirring is stopped and the extrusion and granulation can start.

The compositions in Table 1 were prepared (% by weight) according to the following general protocol:

### Compounding for the Preparation of the Granules of Said Formulations:

Twin screw extruder, such as Coperion ZSK 26 MC, with at least 1 lateral raw material inlet

Machine temperature: 270C
Screw speed: 250 rpm
Extruder output: 16 kg/h

### Transformation:

Wafers 100×100×2 mm3 were made by injection moulding for the measurements of the dielectric properties. The following parameters were used:
ENGEL VICTORY 500, 160T hydraulic press
Injection temperature (feed/nozzle): 265C/280C
Mold temperature: 100C
Holding time: 10 s
Material holding pressure: 700 bar
Cooling time: 35 s

Dumbbell-shaped specimens according to ISO 527-2 1A were produced by injection molding for the measurement of tensile mechanical properties. The following parameters were used:
ENGEL VICTORY 500, 160T hydraulic press
Injection temperature (feed/nozzle): 285C/295C
Mold temperature: 100C
Holding time: 10 s
Material holding pressure: 700 bar
Cooling time: 15 s

The results obtained from the compositions of the invention are shown in the following Table 1 and Table 2:

TABLE 1

| | I1 | I2 | I3 | I4 | I5 | I6 | I7 | I8 | I9 |
|---|---|---|---|---|---|---|---|---|---|
| 11/B10 | | | | | | 27.72 | 23.72 | | |
| PA11 | 19.6 | 15.6 | 19.6 | 15.6 | | | | 11.9 | 11.9 |
| MXD10 | 8.12 | 8.12 | 8.12 | 8.12 | 8.12 | | | 6.82 | 6.82 |
| PA11 oligo mono-NH2 | | 4 | | 4 | 10 | | 4 | 4 | 4 |
| PPH 5060 | 9 | 9 | 9 | 9 | 9 | 9 | 9 | 9 | 9 |
| CA 100 | 3 | 3 | 3 | 3 | 3 | 3 | 3 | 3 | 3 |
| Antioxidant | 0.1 | 0.1 | 0.1 | 0.1 | 0.1 | 0.1 | 0.1 | 0.1 | 0.1 |
| Secondary antioxidant | 0.18 | 0.18 | 0.18 | 0.18 | 0.18 | 0.18 | 0.18 | 0.18 | 0.18 |
| GF with flat section | 40 | 40 | | | | | | | 45 |
| (NE type) | | | | | | | | | |
| GF with circular | | | 40 | 40 | 40 | 40 | 40 | 45 | |
| section (E type) | | | | | | | | | |
| Hollow glass beads | 20 | 20 | 20 | 20 | 20 | 20 | 20 | 20 | 20 |
| Dk at 1 GHz, 23° C. | 3.1 | 3.0 | 3.3 | 3.1 | 3.1 | 3.3 | 3.2 | 3.4 | 3.2 |
| and 50% RH | | | | | | | | | |
| Tan delta at 1 GHz, | 0.005 | 0.005 | 0.006 | 0.006 | 0.005 | 0.006 | 0.006 | 0.006 | 0.005 |
| 23° C. and 50% RH | | | | | | | | | |
| Modulus of elasticity E | 10.7 | 11.1 | 12.0 | 11.8 | 12.4 | 11.5 | 11.7 | 14.3 | 12.9 |
| (GPa) | | | | | | | | | |

TABLE 2

| | I10 | I11 | I12 | I13 | I14 | I15 |
|---|---|---|---|---|---|---|
| 11/B10 | 8.1 | 19.6 | — | — | 27.7 | — |
| PA11 | 19.6 | — | 27.7 | | — | — |
| MXD10 | — | 8.1 | — | 8.12 | | — |
| 11/10T | — | — | — | — | — | 27.7 |
| PA11 oligo mono-NH2 | — | — | — | — | — | — |
| PPH 5060 | 9 | 9 | 9 | 9 | 9 | 9 |
| CA 100 | 3 | 3 | 3 | 3 | 3 | 3 |
| Antioxidant | 0.1 | 0.1 | 0.1 | 0.1 | 0.1 | 0.1 |
| Secondary antioxidant | 0.2 | 0.2 | 0.2 | 0.2 | 0.2 | 0.2 |
| GF with flat section | — | — | — | — | — | — |
| (NE type) | | | | | | |
| GF with circular section | 40 | 40 | 40 | 40 | 40 | 40 |
| (E type) | | | | | | |
| Hollow glass beads | 20 | 20 | 20 | 20 | 20 | 20 |
| Dk at 1 GHz, 23° C. | 2.96 | 3.03 | 2.95 | 3.11 | 2.99 | 3.05 |
| and 50% RH | | | | | | |
| Tan delta at 1 GHz, 23° C. | 0.007 | 0.006 | 0.007 | 0.004 | 0.006 | 0.007 |
| and 50% RH | | | | | | |
| Modulus of elasticity E | 11.5 | 11.4 | 11.4 | 13.1 | 10.5 | 11.7 |
| (GPa) | | | | | | |

Comparative compositions are shown in the following Table 3:

TABLE 3

| | C1 | C2 | C3 | C4 | C5 | C6 | C7 | C8 | C9 | C10 | C11 | C12 | C13 |
|---|---|---|---|---|---|---|---|---|---|---|---|---|---|
| PA11 | | | | | | | | | 100 | 55 | 45 | 50 | |
| 11/10T | | | | | | | | | | | | | 70 |
| PA10.10 | 27.62 | 27.62 | 27.62 | 60 | 60 | 60 | 85 | 70 | | | | | |
| MXD10 | 11.84 | 11.84 | 11.84 | | | | | | | | | 20 | |
| PPH 5060 | | | | | | | | | | 45 | 55 | 30 | 30 |
| Antioxidant | 0.08 | 0.08 | 0.08 | | | | | | | | | | |
| Secondary antioxidant | 0.16 | 0.16 | 0.16 | | | | | | | | | | |
| lubricant | 0.3 | 0.3 | 0.3 | | | | | | | | | | |
| GF with flat section | | 60 | | 40 | | | | | | | | | |
| (NE type) | | | | | | | | | | | | | |
| GF with circular Section | 60 | | | | 40 | | | | | | | | |
| Nittobo/NEG (E-type) | | | | | | | | | | | | | |
| GF with circular section | | | 60 | | | 40 | | | | | | | |
| S2 (HM type) | | | | | | | | | | | | | |
| Hollow glass beads | | | | | | | 15 | 30 | | | | | |
| Dk at 1 GHz | 4.2 | 3.8 | 3.9 | 3.7 | 4.1 | 3.9 | 2.6 | 2.4 | 2.8 | 2.6 | 2.6 | 2.7 | 2.8 |
| Tan delta at 1 GHz | 0.009 | N/A | | | | | | | | | | | |
| Modulus of elasticity E | 16.0 | 14.0 | 16.0 | 15.0 | 16.0 | 17.0 | 2.0 | 2.0 | 1.2 | 0.9 | 0.9 | 1.2 | 1.4 |
| (GPa) | | | | | | | | | | | | | |

I1 to I9: Invention 1 to 9
C1 to C13: Comparative compositions C1 to C13
N/A: Not tested
PA11: Rilsan (Arkema)
PA11/10T (28/72 by weight)
PA11/B10 (10/90 by weight)
Polypropylene PPH 5060: ungrafted polypropylene homopolymer from Total
Orevac CA 100: maleic anhydride grafted polypropylene (Arkema)
PA oligo: PA11 mono NH2

Antioxidant refers to an antioxidant of the phenolic type.

Secondary antioxidant corresponds to an antioxidant of the phosphite type.

NE glass fibers: NE solid glass fibers with a flat cross-section from Nitto Boseki
E glass fibers: E solid glass fibers with a circular cross-section from Nitto Boseki or Nippon Electric Glass
HM glass fibers: solid fibers with a circular cross-section from AGY (high-modulus glass fibers)
Glass beads: Hollowlite glass beads
Dk, tan delta are measured according to ASTM D-2520-13

The tensile modulus (or modulus of elasticity E) is measured according to ISO 527-1 and 2:2012.

1. A method of using a mixture of solid and hollow glass reinforcements with an alloy consisting of at least one polyamide and at least one polyolefin, said mixture of solid and hollow glass reinforcements comprising from 5 to 50% by weight of hollow glass beads relative to the total of solid and hollow glass reinforcements,
excluding polyamide 6 and 66,
for the dry preparation, at 23° C., of a composition having a modulus at least equal to 8 GPa, and a dielectric constant Dk, less than or equal to 3.5, as measured according to ASTM D-2520-13, at a frequency of at least 1 GHz, at 23° C., under 50% RH.

2. The method according to claim 1, wherein the dielectric loss (tan delta) of said composition is less than or equal to 0.01, as measured on a dry sample, at 23° C., under 50% RH, at a frequency of at least 1 GHz, according to ASTM D-2520-13.

3. The method according to claim 1 or 2, wherein said mixture of solid and hollow glass reinforcements, in addition to hollow glass beads, comprises solid glass fibers selected from circular cross-section glass fibers, flat cross-section glass fibers and a mixture thereof.

4. The method according to claim 3, wherein said mixture of glass reinforcements consists of 50 to 95% by weight of solid glass fibers and 5 to 50% by weight of hollow glass beads.

5. The method according to claim 1 wherein said alloy consists of at least one polyamide and at least one polyolefin, the polyamide/polyolefin weight ratio of which is between 95/5 and 50/50.

6. The method according to claim 1 wherein said at least one polyolefin is selected from grafted polyolefins and non-grafted polyolefins and a mixture thereof.

7. The method according to claim 6, wherein the reactive units of the grafted polyolefin are chosen from esters of unsaturated carboxylic acids.

8. The method according to claim 6, wherein the grafted polyolefin is propylene-based.

9. The method according to claim 6, wherein the ungrafted polyolefin is selected from ethylene, propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicocene, 1-dococene, 1-tetracocene, 1-hexacocene, 1-octacocene and 1-triacontene.

10. The method according to claim 6 wherein the ungrafted polyolefin is propylene-based.

11. The method according to claim 5, wherein said alloy consists of at least one polyamide and a mixture of a polypropylene-based grafted polyolefin and a polypropylene-based non-grafted polyolefin.

12. The method according to claim 1, wherein said at least one polyamide is selected from semi-crystalline polyamides, amorphous polyamides and a mixture thereof.

13. The method according to claim 1, wherein said alloy consists of a single polyamide which is an amorphous polyamide and at least one polyolefin.

14. The method according to claim 13 wherein said amorphous polyamide is a polyamide of formula A/XY, wherein:
A is an aliphatic repeating unit obtained by polycondensation:
of at least one C6 to C18 amino acid, or
of at least one C6 to C18
of at least one C4-C36 aliphatic diamine Ca, with at least one C4-C36 dicarboxylic acid Cb;
XY is an aliphatic repeating unit obtained by polycondensation:
of at least one cycloaliphatic diamine, or of at least one linear or branched aliphatic diamine X and of at least one aromatic dicarboxylic acid or of at least one aliphatic dicarboxylic acid Y.

15. The method according to claim 13, wherein said amorphous polyamide is selected from 11/B10, 12/B10, 11/BI/BT, 11/BI.

16. The method according to claim 1 wherein said alloy consists of a single semi-crystalline polyamide or a mixture of two semi-crystalline polyamides and at least one polyolefin.

17. The method according to claim 16, wherein the semicrystalline polyamide is chosen from aliphatic polyamides.

18. The method according to claim 16, wherein said polyamide mixture is a mixture of an aliphatic polyamide.

19. The method according to claim 17, wherein the aliphatic polyamide is chosen from PA610, PA612, PA1010, PA1012, PA1212, PA11 and PA 12.

20. The method according to claim 17, wherein the aryl-aliphatic polyamide is selected from MXD6, MXD10, MXD12.

21. The method according to claim 17, wherein the semi-aromatic polyamide is chosen from PA11/9T, PA11/10T, PA 11/12T, PA12/9T, PA12/10T, PA12/12T.

22. The method according to claim 11, wherein said alloy consists of a single polyamide which is an amorphous polyamide, and of a mixture of a polypropylene-based grafted polyolefin and a polypropylene-based non-grafted polyolefin.

23. The method according to claim 11, wherein said alloy consists of a mixture of two semi-crystalline polyamides and of a mixture of a polypropylene-based grafted polyolefin and a polypropylene-based non-grafted polyolefin.

24. The method according to claim 1, wherein the composition comprises additives.

25. The method according to claim 1, wherein the composition comprises at least one prepolymer.

26. A composition comprising:
30 to 70% by weight of an alloy consisting of at least one polyamide and at least one polyolefin, the polyamide/polyolefin ratio being from 95/5 to 50/50;
30 to 70% by weight of a mixture of solid and hollow glass reinforcement; excluding polyamide 6 and 66, and
0 to 11% by weight of at least one prepolymer;
0 to 5% by weight of fillers, and
0 to 2% by weight,
the sum of the proportions of each constituent of said composition being equal to 100%.

27. The use of A method of using a composition prepared according to the method of claim 1, for the manufacture of an article.

28. The method according to claim 27, wherein the article is manufactured by injection molding.

29. An article obtained by injection molding with a composition prepared according to the method of claim 1.
